(19) United States
(12) Patent Application Publication
(10) Pub. No.: US 2025/0013705 A1
(43) Pub. Date: Jan. 9, 2025

(54) PAGE DISPLAY METHOD AND APPARATUS, STORAGE MEDIUM, AND ELECTRONIC DEVICE

(71) Applicant: BOE TECHNOLOGY GROUP CO., LTD., Beijing (CN)

(72) Inventor: Min ZHANG, Beijing (CN)

(21) Appl. No.: 18/712,783

(22) PCT Filed: Nov. 29, 2021
(86) PCT No.: PCT/CN2021/134079

§ 371 Date: May 23, 2024

(51) Int. Cl. G06F 16/957

(52) U.S. Cl. CPC G06F 16/9574

(57) ABSTRACT

The present application provides a page display method and apparatus. The method includes: when a query operation for target data in a list page is received, jumping from the list page to a detail page corresponding to the target data, and storing a first page locating identifier of the detail page, the first page locating identifier including a page jump parameter; and obtaining the page jump parameter, and jumping from the detail page back to the list page according to the page jump parameter.

### TECHNICAL FIELD

The present disclosure relates to the computer technical field, and specifically, to a page display method, a page display apparatus, a computer-readable storage medium, and an electronic device.

### BACKGROUND

With the continuous updating of front-end technologies and frameworks, the complexity of page functions and interactions is also increasing. In front-end development, Vue is a progressive framework for building user interfaces. Based on the Vue framework, front-end pages can be quickly developed, such as the development of single-page applications.

When using the Vue framework to develop a single-page application, jumping between pages causes page refresh. For example, after selecting certain data from a filtered list page and jumping to a detail page corresponding to the data, when returning to the list page from the detail page, an initial state of the list page is returned to, without saving a query result after the last filtering. If a user needs to view the query result, a filtering operation needs to be performed again, which degrades the user experience.

It should be noted that the information disclosed in the background section is only for enhancing the understanding of the background of the present disclosure, and therefore may include information that does not constitute prior art known to those of ordinary skill in the art.

### SUMMARY

The present disclosure provides a page display method, a page display apparatus, a computer-readable storage medium, and an electronic device.

The present disclosure provides a page display method, including:
when a query operation for target data in a list page is received, jumping from the list page to a detail page corresponding to the target data, and storing a first page locating identifier of the detail page, wherein the first page locating identifier includes a page jump parameter; and
obtaining the page jump parameter, and jumping from the detail page back to the list page according to the page jump parameter.

In an example embodiment of the present disclosure, the list page comprises an original list page and an intermediate list page;
wherein when the query operation for the target data in the list page is received, jumping from the list page to the detail page corresponding to the target data, and storing the first page locating identifier of the detail page, comprises:
when a trigger operation for a search control in the original list page is received, switching the original list page to the intermediate list page according to the page jump parameter; and
when a query operation for first target data in the intermediate list page is received, jumping from the intermediate list page to a first detail page corresponding to the first target data.

In an example embodiment of the present disclosure, when the query operation for the first target data in the intermediate list page is received, jumping from the intermediate list page to the first detail page corresponding to the first target data includes:
when the query operation for the first target data in the intermediate list page is received, obtaining the page jump parameter and a second page locating identifier of the first detail page;
converting the page jump parameter into a target parameter string through a page jump function;
forming the first page locating identifier of the first detail page by the target parameter string and the second page locating identifier; and
jumping from the intermediate list page to the first detail page according to the first page locating identifier of the first detail page.

In an example embodiment of the present disclosure, converting the page jump parameter into the target parameter string through the page jump function includes:
converting the page jump parameter into an initial parameter string; and
encoding the initial parameter string to obtain the target parameter string.

In an example embodiment of the present disclosure, converting the page jump parameter into the target parameter string through the page jump function includes:
converting the page jump parameter into an initial parameter string;
encoding the initial parameter string to obtain a first parameter string; and
encrypting the first parameter string to obtain the target parameter string.

In an example embodiment of the present disclosure, obtaining the page jump parameter and jumping from the detail page back to the list page according to the page jump parameter includes:
obtaining the target parameter string through a parameter parsing function;
parsing the target parameter string to obtain the page jump parameter; and
jumping from the first detail page back to the intermediate list page according to the page jump parameter.

In an example embodiment of the present disclosure, obtaining the target parameter string through the parameter parsing function includes:
determining, through the parameter parsing function, whether the first page locating identifier of the first detail page satisfies a preset matching rule and whether the first page locating identifier includes a preset parameter; and
when the first page locating identifier of the first detail page satisfies the preset matching rule and the first page locating identifier includes the preset parameter, obtaining the target parameter string.

In an example embodiment of the present disclosure, parsing the target parameter string to obtain the page jump parameter includes:
decoding the target parameter string to obtain the initial parameter string, and converting the initial parameter string into the page jump parameter.

In an example embodiment of the present disclosure, parsing the target parameter string to obtain the page jump parameter includes:
decrypting the target parameter string to obtain the first parameter string; and
decoding the first parameter string to obtain the initial parameter string, and converting the initial parameter string into the page jump parameter.

In an example embodiment of the present disclosure, jumping from the first detail page back to the intermediate list page according to the page jump parameter includes:
assigning a current value of the page jump parameter to an option variable, wherein the option variable is used to save a default value of the page jump parameter; and
jumping from the detail page back to the intermediate list page according to the option variable after assigning.

In an example embodiment of the present disclosure, after jumping from the intermediate list page to the first detail page corresponding to the first target data, the method further includes:
when a query operation for second target data in the first detail page is received, jumping from the first detail page to a second detail page corresponding to the second target data through the page display method according to any one of claims 2 to 10, and storing a page locating identifier of the second detail page; and
obtaining a page jump parameter included in the page locating identifier of the second detail page, and jumping from the second detail page back to the first detail page according to the page jump parameter.

In an example embodiment of the present disclosure, after jumping from the intermediate list page to the first detail page corresponding to the first target data, the method further includes:
when a query operation for second target data in the first detail page is received, jumping from the first detail page to a second detail page corresponding to the second target data, and storing a page locating identifier of the second detail page;
determining the first page locating identifier of the first detail page according to the page locating identifier of the second detail page; and
jumping from the second detail page back to the first detail page according to the first page locating identifier of the first detail page.

In an example embodiment of the present disclosure, the page jump function, the parameter parsing function and the option variable are encapsulated in advance into an executable file which is stored in a browser so that the executable file is executed when the query operation for the target data in the list page is received, wherein:
the page jump function is used to convert the page jump parameter into a target parameter string, the first page locating identifier of the first detail page is formed by the target parameter string and the second page locating identifier, and jumping from the intermediate list page to the first detail page is according to the first page locating identifier of the first detail page;
the parameter parsing function is used to obtain the target parameter string, parse the target parameter string to obtain the page jump parameter, and jumping from the first detail page back to the intermediate list page is according to the page jump parameter; and
the option variable is used to save a default value of the page jump parameter.

The present disclosure provides a page display apparatus, including:
a first page display module configured to, when a query operation for target data in a list page is received, jump from the list page to a detail page corresponding to the target data, and store a first page locating identifier of the detail page, wherein the first page locating identifier includes a page jump parameter; and
a second page display module configured to obtain the page jump parameter, and jump from the detail page back to the list page according to the page jump parameter.

The present disclosure provides a computer-readable storage medium on which a computer program is stored, wherein when the computer program is executed by a processor, the method of any one of the above embodiments is implemented.

The present disclosure provides an electronic device, including:
a processor; and
a memory configured to store instructions executable by the processor;
wherein the processor is configured to execute the executable instructions to implement the method of any one of the above embodiments.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of the specification, illustrate embodiments consistent with the present disclosure and together with the specification serve to explain the principles of the present disclosure. Apparently, the drawings in the following description are only some embodiments of the present disclosure, and those skilled in the art may obtain other drawings according to these drawings without creative efforts.

FIG. 1 shows a schematic diagram of an example system architecture in which a page display method and apparatus according to embodiments of the present disclosure can be applied;

FIG. 2 schematically shows a flow chart of a page display method according to an embodiment of the present disclosure;

FIG. 3 schematically shows a flow chart of jumping from a list page to a detail page according to an embodiment of the present disclosure;

FIG. 4 schematically shows a flow chart of jumping from the detail page back to the list page according to an embodiment of the present disclosure;

FIG. 5 schematically shows a flow chart of jumping from the detail page back to the list page according to another embodiment of the present disclosure;

FIG. 6 schematically illustrates a schematic diagram of a list page according to an embodiment of the present disclosure;

FIG. 7 schematically shows a schematic diagram of a list page with a query condition according to an embodiment of the present disclosure;

FIG. 8A schematically shows a schematic diagram of a work order detail page according to an embodiment of the present disclosure;

FIG. 8B schematically shows a work order detail page containing list data according to an embodiment of the present disclosure;

FIG. 8C schematically shows a schematic diagram of a work order detail page with a filtering condition according to an embodiment of the present disclosure;

FIG. 9A schematically shows a schematic diagram of a detail page of a related picture in a work order detail page according to an embodiment of the present disclosure;

FIG. 9B schematically shows a schematic diagram of a detail page of a no-intrusion area according to an embodiment of the present disclosure;

FIG. 10 schematically shows a block diagram of a page display apparatus according to an embodiment of the present disclosure; and

FIG. 11 schematically shows a structural diagram of a computer system suitable for implementing an electronic device according to an embodiment of the present disclosure.

### DETAILED DESCRIPTION

Example implementations will now be described more fully with reference to the accompanying drawings. Example implementations may, however, be embodied in many forms and should not be construed as being limited to the implementations set forth herein; rather, these implementations are provided so that the present disclosure will be thorough and complete, and will fully convey the concept of example implementations to those skilled in the art. The described features, structures or characteristics may be combined in any suitable manner in one or more implementations. In the following description, numerous specific details are provided to give a thorough understanding of implementations of the present disclosure. However, those skilled in the art will appreciate that the technical solutions of the present disclosure may be practiced without one or more of the specific details described, or other methods, components, devices, steps, etc. may be adopted. In other situations, well-known technical solutions are not shown or described in detail to avoid obscuring aspects of the present disclosure.

Furthermore, the drawings are merely schematic illustrations of the present disclosure and are not necessarily drawn to scale. The same reference numerals in the drawings represent the same or similar parts, and thus their repeated description will be omitted. Some of the block diagrams shown in the drawings are functional entities and do not necessarily correspond to physically or logically separate entities. These functional entities may be implemented in software form, or implemented in one or more hardware modules or integrated circuits, or implemented in different networks and/or processor devices and/or microcontroller devices.

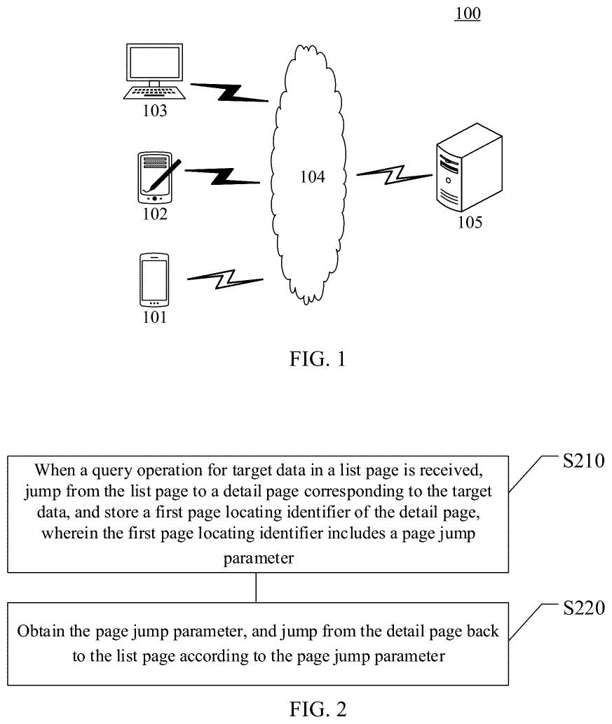

FIG. 1 shows a schematic diagram of a system architecture of an example application environment in which a page display method and apparatus according to embodiments of the present disclosure can be applied.

As shown in FIG. 1, the system architecture 100 may include one or more of terminal devices 101, 102, and 103, a network 104 and a server 105. The network 104 is a medium configured to provide communication links between the terminal devices 101, 102, and 103 and the server 105. The network 104 may include various connection types, such as wired or wireless communication links, or fiber optic cables, and so on. The terminal devices 101, 102, and 103 may be various electronic devices, including but not limited to desktop computers, portable computers, smart phones, tablets, etc., and are configured to provide user interfaces for page display. For example, a client (such as a browser) is installed on a terminal device, and a page can be browsed through the browser client. Specifically, the browser on the terminal device may be configured to perform the following: when a query operation for target data in a list page is received, jumping from the list page to a detail page corresponding to the target data, and storing a first page locating identifier of the detail page, wherein the first page locating identifier includes a page jump parameter; and obtaining the page jump parameter, and jumping from the detail page back to the list page according to the page jump parameter. It should be understood that the number of terminal devices, number of network(s) and number of server(s) in FIG. 1 are merely illustrative. Depending on implementation needs, there may be any number of terminal devices, networks, and servers. For example, the server 105 may be one server, a server cluster formed by multiple servers, or a cloud computing platform or a virtualization center. In addition, the server 105 may be configured to provide a background service for a view component that supports page display, etc.

The page display method provided by the embodiments of the present disclosure is generally executed by one or more of the terminal devices 101, 102, and 103. Correspondingly, the page display apparatus is generally provided in the terminal device 101, terminal device 102, and/or terminal device 103. For example, after execution of a terminal device, the last query result can be directly displayed on a display screen of the terminal device, which is not particularly limited in this example embodiment. However, those skilled in the art can easily understand that the page display method provided by the embodiments of the present disclosure may alternatively be executed by the server 105. Correspondingly, the page display apparatus may be provided in the server 105, and the server can retain a query condition selected by a user, so that when the page jumping is performed, the last query result can be returned according to the query condition, and the terminal device can display the query result to the user.

The technical solutions of the embodiments of the present disclosure will be described in detail below.

With the continuous updating of front-end technologies and frameworks, the complexity of page functions and interactions is also increasing. In front-end development, Vue is a progressive framework for building user interfaces. Based on the Vue framework, front-end pages can be quickly developed, such as the development of single-page applications.

When using the Vue-Cli framework (a scaffolding tool in the Vue framework) to develop a single-page application, jumping between pages causes page refresh. For example, after selecting certain data from a filtered list page and jumping to a detail page corresponding to the data, when you return to the list page from the detail page, the initial state of the list page is returned to, without saving a query result after the last filtering. If a user needs to view the query result, a filtering operation needs to be performed again, which degrades the user experience.

In related art, a query condition of a list page may be retained by a Uniform Resource Locator (URL) parameter to retain the state of the list page. However, this method directly puts the query condition into a URL, which is neither safe nor aesthetic. In addition, after entering the detail page from the list page, the query condition may be saved in the detail page URL. When returning to the list page from the detail page, the query condition needs to be put into the list page URL. The list page reads the query condition in the URL and requests data from the background. During the page jump procedure, although the detail page itself does not need to use the query condition, in order to add the query condition to the list page URL when returning to the list page, the detail page needs to read and parse the query condition in the current URL. Adding the query condition to the list page URL to form a new target URL and then jumping increases the workload of modifying the detail page, reduces the user's operating efficiency, and thus affects the user experience.

In view of one or more of the above problems, an example implementation provides a page display method, which may be applied to one or more of the above terminal devices 101, 102, 103, or may be applied to the above server 105, and there is no special limitation on this in the example embodiment. Referring to FIG. 2, the page display method may include step S210 and step S220:

In step S210, when a query operation for target data in a list page is received, jumping from the list page to a detail page corresponding to the target data is performed, and a first page locating identifier of the detail page is stored. The first page locating identifier includes a page jump parameter.

In step S220, the page jump parameter is obtained, and jumping from the detail page back to the list page is performed according to the page jump parameter.

In the page display method provided by the example embodiment of the present disclosure, when the query operation for the target data in the list page is received, jumping from the list page to the detail page corresponding to the target data is performed, and the first page locating identifier of the detail page is stored, and the first page locating identifier includes the page jump parameter; the page jump parameter is obtained, and jumping from the detail page back to the list page is performed according to the page jump parameter. The present disclosure can retain the page jump parameter when entering the detail page from the list page. When returning from the detail page, the previous list page can be restored according to the page jump parameter so as to avoid page refresh due to page jump, and the user can obtain the last query result without need of performing an operation again, thus improving the user experience.

Below, the above-mentioned steps of the example embodiment will be described in more detail.

In step S210, when the query operation for the target data in the list page is received, jumping from the list page to the detail page corresponding to the target data is performed, and the first page locating identifier of the detail page is stored; the first page locating identifier includes the page jump parameter.

In an example implementation of the present disclosure, the page display of a list page and several detail pages in a single-page application may be used as an example for explanation. A single-page application refers to an application program with only one main page. When the application program is run in a browser, the system only needs to load a resource once. Subsequent operation interaction and data interaction are implemented through Router (routing), and AJAX (Asynchronous Javascript And XML, a web development technology for creating an interactive web application). The list page and detail page may be user interfaces developed by the Vue-Cli framework. Specifically, the list page may be a user interface used to display highly repetitive interface elements in an application program, and the order, position, and data source of each interface element may be controlled through the Vue-Cli framework. A detail page may be a user interface in an application program for displaying detailed content for an interface element. For example, the interface elements may include a status bar, a navigation bar, a main menu bar, a content area, etc., and the present disclosure does not specifically limit this. For example, for an application program used for operation and maintenance services, the main menu bar of the list page may include tasks such as “Work Order Management”, “User Management” and “Information Base Management”, and the content area may be work order list data corresponding to the “Work Order Management” task, or may be user list data corresponding to the “User Management” task, or may be information base list data corresponding to the “Information Base Management” task.

When a user queries the details of certain data in the list page, the user needs to enter a query condition related to the data on the list page. In an example implementation of the present disclosure, the query condition may include a filtering condition and a paging condition. The filtering condition may be information such as name, status, etc., and the paging condition may be information such as page number, number of data items per page, etc. For example, if the user performs search based on the name in the list page, and the filtering condition of the list page is “name: 1”, it can mean to find all the data in the list page that contains “1” in the name. If the user performs search based on the page number in the list page, and the paging condition of the list page is “pageNum: 2”, it can mean selecting certain data on the second page to view the details of the data. It should be noted that the list page may include an original list page and an intermediate list page. The original list page may be the initial state of the list page, and the intermediate list page may be a list page with both a filtering condition and a paging condition. For example, after filtering the original list page using a filtering condition (such as name: 1), the original list page may be switched to the intermediate list page (that is, the second page) according to the paging condition (such as pageNum: 2), and after selecting certain data in the second page, jumping to a detail page of the data may be performed. At this time, the corresponding query condition is: “name: 1, pageNum: 2”. It is understandable that the original list page may be, by default, the data of the first page without a filtering condition, and the corresponding query condition is “name:″, pageNum: 1”.

In an example implementation, when a trigger operation on a search control in the original list page is received, the original list page may be switched to an intermediate list page according to the page jump parameter. When a query operation for first target data in the intermediate list page is received, jumping from the intermediate list page to a first detail page corresponding to the first target data may be performed, and the first page locating identifier of the first detail page is stored in the browser. For example, the first page locating identifier may be buffered, or the first page locating identifier may be temporarily stored in the browser, and the present disclosure does not specifically limit this. The page jump parameter may be a query condition input by a user on the original list page, the first target data may be any list data in the intermediate list page that is associated with the detail page, and the first detail page may be the first page displayed when performing the operation of querying details for the first target data, and the first page locating identifier may be the URL of the first detail page. It should be noted that in an example embodiment of the present disclosure, if the URL of a page does not change but the list data in the page changes, it can mean that page switching is carried out. If both the URL of the page and the list data in the page change, it can mean that the page jump is carried out.

For example, after the user enters a query condition “name: 1, pageNum: 2”, the user may click or short-press the search control, so that the browser may switch the original list page to the second list page containing the name “1” according to the query condition. When the user selects the first target data on the second list page and performs a query operation on the data, jumping from the second list page to a detail page associated with the data may be performed. It can be seen that when switching the original list page to the second list page, the URLs of the original list page and the second list page are the same, but when jumping from the second list page to the detail page, the URLs of the second list page and the detail page are not the same.

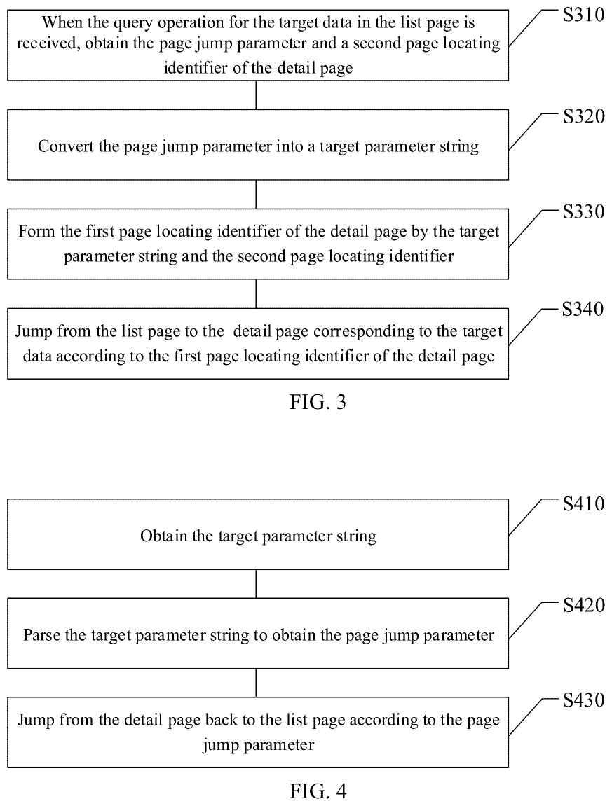

Referring to FIG. 3, jumping from the intermediate list page to the first detail page corresponding to the first target data may be implemented according to steps S310 to S340.

In step S310, when a query operation for first target data in the intermediate list page is received, the page jump parameter and a second page locating identifier of the first detail page are obtained.

For example, for an intermediate list page with both a filtering condition and a paging condition, when a query operation for the first target data in the intermediate list page is received, a page jump function may be called, and the page jump function may be used to jump from the intermediate list page to the detail page corresponding to the first target data. The query operation may be a user's click/tap/short-press operation on the search control on the intermediate list interface, which is not specifically limited in the present disclosure. In an example embodiment of the present disclosure, the page jump function may be a jump function. When using the jump function to jump from the intermediate list page to the first detail page, a corresponding query condition may be recorded, so that the query condition may be read when returning from the first detail page, and the last query result may be restored based on the read query condition. This eliminates the need for the user to filter the original list page again, which can improve the user experience.

When calling the jump function, parameters related to the first detail page need to be passed in, which may include the page jump parameter and the second page locating identifier of the first detail page, etc. For example, the page jump parameter may be the query condition which the intermediate list page has, and the second page locating identifier of the first detail page may be an initial URL of the first detail page. Correspondingly, the parameters Router, path and options may be passed in. The Router may be a Vue Router object, and Path is a jump target URL, which is the initial URL of the first detail page and is a string type variable. For example, the Path may be “/alarmMgmt/detail/1”. The options is a query condition that needs to be recorded and is an object type variable. For example, the query condition is to filter the original list page according to the filtering condition “name is name1, status is type1”, and then switch from the original list page to the intermediate list page according to the paging condition “second page, each page contains 10 pieces of data”, to query the first target data in the intermediate list page, and the options passed in corresponding to the query condition may be {pageNum: 2, pageSize: 10, name: ‘name1’, type: ‘type1’}.

In step S320, the page jump parameter is converted into a target parameter string through the page jump function.

After the passing of parameter is completed, the page jump parameter may be converted into the target parameter string through the page jump function. The page jump parameter may be the query condition options which the intermediate list page has. The target parameter string may be a params string. It should be noted that the purpose of converting the page jump parameter into the target parameter string is to convert the page jump parameter into content that can be uniformly recognized by the page jump function, so as to facilitate unified integrated management and operation. For example, the jump function may be used to convert the options object into a params string. If the options is {pageNum: 2, pageSize:10, name: ‘name1’, type: ‘type1’}, the converted params string may be {“pageNum”:2, “pageSize”:10, “name”: “name1”, “type”: “type1”}, as shown in Table 1.

TABLE 1

| | |
|---|---|
| options object | {pageNum:2, pageSize:10, name: ‘name1’, type: ‘type1’} |
| params string | {“pageNum”:2, “pageSize”:10, “name”: “name1”, “type”: “type1”} |

In one example, in order to increase the security of the URL of the detail page, the query condition may also be encoded when converting the page jump parameter into target parameter string. For example, the page jump parameter may be converted into an initial parameter string, and the initial parameter string may be encoded to obtain the target parameter string. Specifically, the jump function may be used to convert the options object into a params string, and the params string is the initial parameter string. The encodeURIComponent function may be used to perform UTF-8 (8-bit Unicode Transformation Format, variable length character encoding) encoding on the params string. The encoded params string is the target parameter string. The encodeURIComponent function may encode a string as a URI component. For example, the encoded params string may be: “% 7BpageNum %3 Apagesize % 22 . . . ”, as shown in Table 2.

TABLE 2

| | |
|---|---|
| options object | {pageNum:2, pageSize:10, name: ‘name1’, type: ‘type1’} |
| params string | {“pageNum”:2, “pageSize”:10, “name”: “name1”, “type”: |
| | “type1”} |
| encoded params string | %7BpageNum%3Apagesize%22 ... |

It can be seen that the parameter name in the query condition such as pageNum, pagesize, etc. can be seen from the encoded params string, but the parameter value of each parameter cannot be obtained, which can improve the security of the URL of the detail page.

In one example, on the basis of increasing the security of the URL of the detail page, in order to increase the aesthetics of the URL of the detail page, the query condition may be encoded first and the encoded query condition may be encrypted. For example, the page jump parameter may be converted into an initial parameter string, the initial parameter string may be encoded to obtain a first parameter string, and then the first parameter string may be encrypted to obtain the target parameter string.

Specifically, first, the jump function may be used to convert the options object into a params string, and the params string is the initial parameter string. Then, the encodeURIComponent function may be used to encode the params string, and the encoding result of the params string may be encrypted. Base64 encoding may be performed on the encoding result of the params string to encrypt the encoding result of the params string. It is understandable that the encryption method may also be MD5 (message-digest algorithm 5), SHA1 (Secure Hash Algorithm 1), Crypto-JS (a JavaScript encryption algorithm), etc., and the present disclosure does not specifically limit this. The encoded params string is the first parameter string, and the encrypted params string is the target parameter string. For example, the encrypted params string may be “JTdCJTIycGFnZU51 . . . ”, as shown in Table 3.

TABLE 3

| | |
|---|---|
| options object | {pageNum:2, pageSize:10, name: ‘name1’, type: ‘type1’} |
| params string | {“pageNum”:2, “pageSize”:10, “name”: “name1”, “type”: |
| | “type1”} |
| encoded params string | %7BpageNum%3Apagesize%22 ... |
| encrypted params | JTdCJTIycGFnZU51 ... |
| string | |

It can be seen that the parameter information related to the query condition cannot be read from the encrypted params string, which further increases the security of the URL of the detail page and also improves the aesthetics of the URL of the detail page. In other examples, after converting the options object into a params string using the jump function, the params string may be directly encrypted, and jumping to the path page with the encrypted params string may be performed, and the present disclosure does not specifically limit this. The params string may also be encrypted in multiple layers. For example, Base64 encoding, MD5 encryption, and SHA1 encryption etc. may be performed in sequence on the encoding result of the params string to further increase the security of the URL of the detail page, and the present disclosure does not specifically limit this.

In step S330, the first page locating identifier of the first detail page is formed by the target parameter string and the second page locating identifier.

After obtaining the target parameter string, the first page locating identifier of the first detail page may be constituted by the target parameter string and the second page locating identifier of the first detail page, so as to jump from the intermediate list page to the first detail page according to the first page locating identifier of the first detail page. The first page locating identifier of the first detail page may be a new URL formed by the initial URL of the first detail page carrying the params string. When jumping from the intermediate list page to the first detail page, the new URL of the first detail page may be saved. The new URL includes the params string, that is, the new URL includes the query condition which the intermediate list page has.

In step S340, jumping from the intermediate list page to the first detail page is performed according to the first page locating identifier of the first detail page.

After getting the params string, a push method of the parameter Router may be called. The parameters of the push method which are passed in are: {path, query: {o: params}}, and jumping to the path page carrying the params string is performed, realizing the jump from the intermediate list page to the first detail page.

For example, the params string converted from the options object is {“pageNum”:2, “pageSize”:10, “name”: “name1”, “type”: “type1”}, the initial URL of the first detail page can carry the params string to form the current URL of the first detail page. The current URL of the first detail page may be “/alarmMgmt/detail/1?o-“pageNum”:2, “pageSize”:10, “name”: “name1”, “type”: “type1””.

In an example implementation, after obtaining the params string by converting the options object, the encodeURIComponent function is used to encode the params string, and the encoded params string obtained is “% 7BpageNum %3Apagesize %22 . . . ”. The push method of the parameter Router can also be called to jump to the path page carrying the encoded params string, realizing the jump from the intermediate list page to the first detail page. For example, the initial URL of the first detail page may carry a params string to form the current URL of the first detail page. The current URL may be “/alarmMgmt/detail/1? o=% 7BpageNum % 3Apagesize %22 . . . ”.

In an example implementation, after obtaining the params string by converting the options object, the encodeURIComponent function is used to encode the params string, and the encoding result is encrypted to obtain the params string “JTdCJTlycGFnZU51 . . . ”. The push method of the parameter Router may also be called to jump to the path page carrying the encrypted params string, realizing the jump from the intermediate list page to the first detail page. For example, the initial URL of the first detail page may carry a params string to form the current URL of the first detail page. The current URL may be “/alarmMgmt/detail/1? o=% JTdCJTIycGFnZU51 . . . ”.

In this example, when using the vue-cli framework to develop a single-page application, it is only needed to add a page jump function to the list page source code to jump from the list page to the detail page. The query condition can be recorded when page jump is carried out, so that the query condition can be read when returning from the detail page, and the last query result can be restored based on the read query condition without modifying the detail page. This can reduce the user's workload, and improve the user's page operation efficiency.

In step S220, the page jump parameter is obtained, and jumping from the detail page back to the list page is performed according to the page jump parameter.

In an example implementation of the present disclosure, an option variable optionsDefault may be defined, and the option variable may be used to save a default value of the page jump parameter. For example, it may be used to save the initial query condition of the list page. If the initial query condition is {pageNum: 1, pageSize: 10}, it means that each page contains ten pieces of data by default, and the data on the first page is obtained for display. When entering the list page, optionsDefault is be used by default as the query condition and the corresponding list data is obtained. It can be understood that when the query condition of the list page is the initial query condition, what is displayed is the initial state of the list page, that is, the original list page. When the user queries details of certain data on the first page, jumping from the original list page to the detail page of the data may be performed. When returning from the detail page, optionsDefault is used as the query condition. At this time, optionsDefault is the initial query condition, and what is obtained according to the initial query condition is the list data of the first page, that is, jumping directly back to the original list page from the detail page can be realized.

When the user queries details of certain data in the intermediate list page, jumping from the intermediate list page to the detail page of the data may be performed. When returning from the detail page, optionsDefault is used as the query condition, and what is obtained according to the initial query condition is the list data of the intermediate list page, that is, jumping back to the intermediate list page from the detail page can be realized. When the user views the detailed content of the target data on the detail page and returns from the detail page, in order to avoid losing the last query result when returning from the detail page to the original list page due to page refresh, a parameter parsing function may be called, and the parameter parsing function may be used to return from the detail page to a list page that retains the last query results, that is, return to the intermediate list page. In example implementations of the present disclosure, the parameter parsing function may be a getQuery function. For example, when the user's trigger operation on a page go-back control in the browser interface is received, the getQuery function may be called to use the getQuery function to complete the acquisition and parsing of the last query condition before entering the list page, so as to facilitate restoring of the last query result according to the parsing result. This can eliminate the need for users to perform an operation such as filtering the list page again, which improves the user experience.

In the example implementation of the present disclosure, the Vue framework is used to implement page display of a single-page application. Therefore, the navigation guard beforeRouteEnter hook function in the Vue Router component can be used to call the getQuery function before the page is rendered. Referring to FIG. 4, steps $410 to S430 may be used to jump from the detail page back to the list page that retains the last query result. For example, it is possible to jump from the first detail page back to the intermediate list page.

In step S410, the target parameter string is obtained through the parameter parsing function.

Specifically, when calling the getQuery function, parameter(s) used to extract the last query condition may be passed in, which may include parameters reg, from, and next. The reg is a regular expression, and reg may be used to match the detail page URL corresponding to the current list page. The from and the next may be obtained from the beforeRouteEnter hook function. The from is object type data. The information of the page before entering the list page may be obtained through from. The next is a jump function. The beforeRouteEnter hook function requires that the next function must be called after the service code is executed, marking the completion of the function and entering the page loading procedure.

After the passing of parameter is completed, the getQuery function may be used to obtain the target parameter string. For example, when returning from the first detail page, the getQuery function may be first used to check whether the first page locating identifier of the first detail page meets the condition for obtaining the target parameter string. For example, when the first detail page URL meets a preset matching rule and the first detail page URL contains a preset parameter, the target parameter string may be obtained from the first detail page URL, and the last query condition may be extracted from the target parameter string. The preset matching rule may be the matching rule of the regular expression reg, and the regular expression reg may be /\hat{ }ValarmMgmtVdetail.*$/, and the preset parameter can be a parameter named “o”. That is, only when returning to the list page from the detail page URL which starts with/alarmMgmt/detail and carries the parameter “o”, it is needed to extract the query condition and restore the list data based on the query condition. For example, the URL of the detail page that meets the extraction of query condition may be: /alarmMgmt/detail/92284?o=JTdCJTIycGFnZVN . . . .

Specifically, from.fullPath may save the complete URL of the page before entering the list page. The URL needs to meet the matching rule of the regular expression reg. The page before entering the list page may be a specified page, such as a detail page corresponding to the list page. At the same time, from.query may save the parameter(s) carried by the URL of the page before entering the list page. The parameter “o” needs to be included in the URL parameter(s). It can be seen that the detail page URL meets the matching rule of the regular expression reg. If the URL contains the parameter “o”, the last query condition may be extracted from the URL. It should be noted that the target parameter string is stored in the from.query.o variable, and thus the query condition can only be extracted when the URL parameter(s) contains (contain) the parameter “o”. It can be understood that if the URL of the page before entering the list page does not meet the matching ruls of the regular expression reg, or does not meet the parameter “o” being included in the URL parameter(s), it can indicate that this page jump is not from the specified detail page back to the list page, or the URL of the detail page does not carry the query condition. At this time, next ( ) may be directly executed to enter the list page, that is, return to the initial state of the list page.

In step S420, the target parameter string is parsed to obtain the page jump parameter.

After obtaining the target parameter string from the first detail page URL, the target parameter string may be parsed, that is, the from.query.o variable may be parsed to obtain the page jump parameter. For example, if the parameter “o” in the variable (that is, the target parameter string) is the params string {“pageNum”: 2, “pageSize”: 10, “name”: “name1”, “type”: “type1”}, the params string may be restored to the object type data options {pageNum: 2, pageSize: 10, name: ‘name1’, type: ‘type1’}.

In an example implementation, the target parameter string may also be decoded to obtain an initial parameter string, and the initial parameter string may be converted into the page jump parameter. For example, if the target parameter string is the params string “% 7BpageNum %3Apagesize %22 . . . ”, the decodeURIComponent function may be used to decode the params string. Through decoding, the params string {“pageNum”: 2, “pageSize”: 10, “name”: “name1”, “type”: “type1”} may be obtained, and this params string is the initial parameter string. Then, the params string may be restored to the object type data options {pageNum: 2, pageSize: 10, name: ‘name1’, type: ‘type1’}.

In an example implementation, the target parameter string may also be decrypted to obtain a first parameter string, and then the first parameter string may be decoded to obtain the initial parameter string, and the initial parameter string may be converted into the page jump parameter. For example, when jumping from the list page to the detail page, the options object is first converted into a params string, then the encodeURIComponent function is used to encode the params string, and the encoding result of the params string is Base64-encoded, and the encoding result of the params string encrypted to obtain the params string “JTdCJTlycGFnZU51 . . . ”. When parsing the params string, the params string is first decoded. Corresponding to the encoding sequence, Base64 decoding may be performed first on the params string to decrypt the params string, and then the decodeURIComponent function is used to decode the decrypted params string. The decrypted params string is the first parameter string. By decoding, the params string {“pageNum”: 2, “pageSize”: 10, “name”: “name1”, “type”: “type1”} may be obtained, and the params string is the initial parameter string. Then, the params string may be restored to the object type data options {pageNum: 2, pageSize: 10, name: ‘name1’, type: ‘type1’}.

In step S430, jumping from the first detail page back to the intermediate list page is performed according to the page jump parameter.

After extracting the page jump parameter, the current value of the page jump parameter may be assigned to the option variable optionsDefault to jump back to the intermediate list page from the first detail page based on the option variable after assigning. For example, after the assigning is completed, the option variable optionsDefault changes from the initial query condition {pageNum: 1, pageSize: 10} to options {pageNum: 2, pageSize: 10, name: ‘name1’, type: ‘type1’}, and by calling and executing next ( ) to enter the intermediate list page, jumping from the detail page back to the list page that retains the last query result can be realized.

In this example, when using the Vue-cli framework to develop a single-page application, it is only needed to add a parameter parsing function in the source code of the list page to jump from the detail page back to the list page that retains the last query result. When returning from the detail page, the query result of the list page is restored by reading the previously recorded query condition without modifying the source code of the detail page, which reduces the user's workload and improves the user's page operation efficiency.

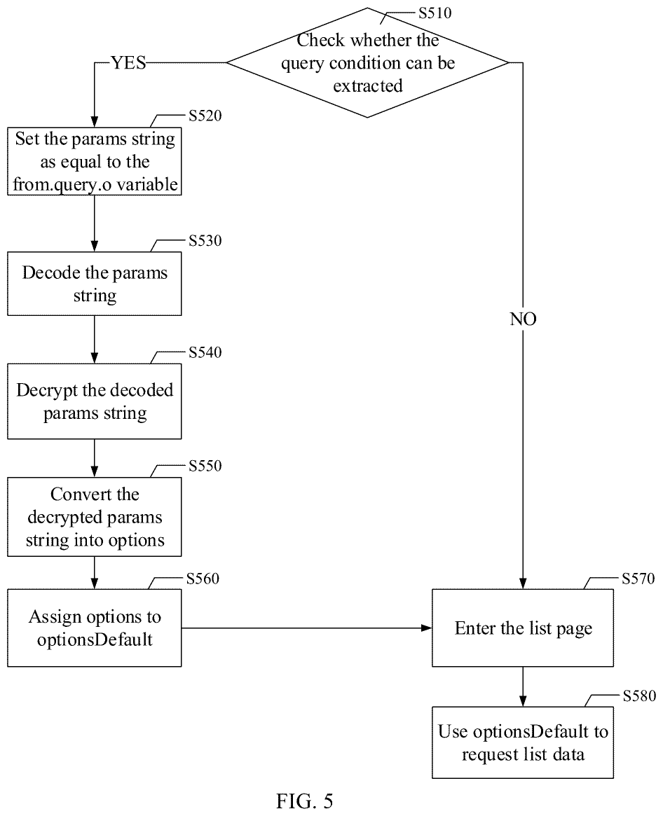

In an example implementation, referring to FIG. 5, jumping from the detail page back to the list page can be implemented according to steps S510 to S580.

In step S510, whether the query condition can be extracted is checked. That is, the information of the page before entering the list page can be obtained through from, where from.fullPath saves the URL of the page before entering the list page, and from.query saves parameter(s) carried by the URL of the page before entering the list page. Whether from.fullPath can match the regular expression reg, and whether from.query contains parameter o are checked; if yes, it means that the query condition can be extracted from the URL of the page before entering the list page, and then step S520 is executed; if not, it means that the URL of the page before entering the list page does not carry the query condition or this page jump is not from the specified detail page back to the list page, then step S570 is executed.

In step S520, the params string is set as equal to the from.query.o variable, that is, the URL parameter o of the page before entering the list page contains the params string, and the params string can be stored in the from.query.o variable.

In step S530, the params string is decoded, that is, the from.query.o variable is decoded.

In step S540, the decoded params string is decrypted.

In step S550, the decrypted params string is converted into options.

In step S560, options is assigned to optionsDefault.

In step S570, entering the list page is performed. For example, next ( ) may be executed to enter the list page.

In step S580, optionsDefault is used to request list data, render the list data and the data is displayed to the user through the terminal device.

It is understandable that when a user queries the details of certain data in the original list page, jumping from the original list page to the detail page of the data may be performed. When returning from the detail page, optionsDefault is used as the query condition. At this time, the optionsDefault is still the initial query condition after being assigned a value. According to the initial query condition, the list data of the first page is obtained, that is, it is possible to jump directly from the detail page back to the initial state of the list page. This can also implement the function of retaining the last query result when returning to the list page from the detail page.

In an example implementation of the present disclosure, two steps are required to retain the last query result when returning to the list page from the detail page. First, the page jump function (such as the jump function) in the list page source code is modified, and the encoding result of the query condition options is passed in. Second, the beforeRouteEnter hook function is added in the list page source code to call the parameter parsing function (such as the getQuery function), the parameter parsing function may be used to read and parse the URL parameter(s) of the page before entering the list page to obtain the last query condition options, and the page default query condition (that is, the option variable optionsDefault) is modified to the last query condition option. In this way, restoration of the last query result on the list page can be completed. This method only needs to add the page jump function and the parameter parsing function in the list page source code without modifying the detail page source code, which reduces the workload required by the user to complete this function and improves the user's operational efficiency. In addition, URL parameter(s) is (are) encoded, increasing the security and aesthetics of the URL.

In an example implementation, after jumping from the intermediate list page to the first detail page corresponding to the first target data, the first detail page may include at least one piece of second target data. The second target data may be list data related to the details of the target data. When a query operation for the second target data in the first detail page is received, jumping from the first detail page to a second detail page corresponding to the second target data may be performed according to steps S210 and S220, and the page locating identifier of the second detail page may be stored. The page jump parameter contained in the page locating identifier of the second detail page may be obtained, and jumping back to the first detail page from the second detail page may be performed according to the page jump parameter.

For example, when jumping from the intermediate list page to the first detail page, the first detail page may also include multiple pieces of list data related to the details of the first target data. The user may perform filtering on the multiple pieces of list data in the first detail page to obtain the filtered first detail page. At this time, the first detail page has a filtering condition. In other examples, the filtered first detail page may also have both a filtering condition and a paging condition, and the present disclosure does not specifically limit this. Then, when a query operation for certain list data in the filtered first detail page is received, jumping from the filtered first detail page to a second detail page corresponding to the list data may be performed according to steps S310 to S340, and the page locating identifier of the second detail page may be stored. When a user's trigger operation on the page go-back control in the browser interface is received, the page jump parameter contained in the page locating identifier of the second detail page may be obtained according to steps S410 to S430, and jumping back to the filtered first detail page from the second detail page may be performed according to the page jump parameter.

In another example implementation, after jumping from the intermediate list page to the first detail page corresponding to the first target data, the first detail page may include at least one piece of second target data, and the second target data is used to represent details of the first target data. When a query operation for the second target data in the first detail page is received, jumping from the first detail page to a second detail page corresponding to the second target data may be performed, and the page locating identifier of the second detail page may be stored. The first page locating identifier of the first detail page may be determined according to the page locating identifier of the second detail page, and jumping back to the first detail page from the second detail page may be performed according to the first page locating identifier of the first detail page.

For example, when jumping from the intermediate list page to the first detail page, the URL of the first detail page may be “/alarmMgmt/detail/1? o=% JTdCJTlycGFnZU51”. When a query operation for certain second target data is received, jumping from the first detail page to a second detail page corresponding to the second target data may be performed. For example, the URL of the second detail page may be “/alarmMgmt/detail/1? o=% JTdCJTlycGFnZU51/picture”, and at the same time, the URL of the second detail page may be stored in the browser. When returning from the second detail page, the URL of the second detail page may be obtained, so as to determine the URL of the first detail page according to the URL of the second detail page. For example, if the obtained URL of the second detail page is “/alarmMgmt/detail/1? o=% JTdCJTIycGFnZU51/picture”, since the URL of the first detail page is formed by the initial URL of the first detail page and the parameter o, it can be determined that the URL of the first detail page is “/alarmMgmt/detail/1? o=% JTdCJTlycGFnZU51”. Finally, the first detail page is navigated to according to the URL of the first detail page.

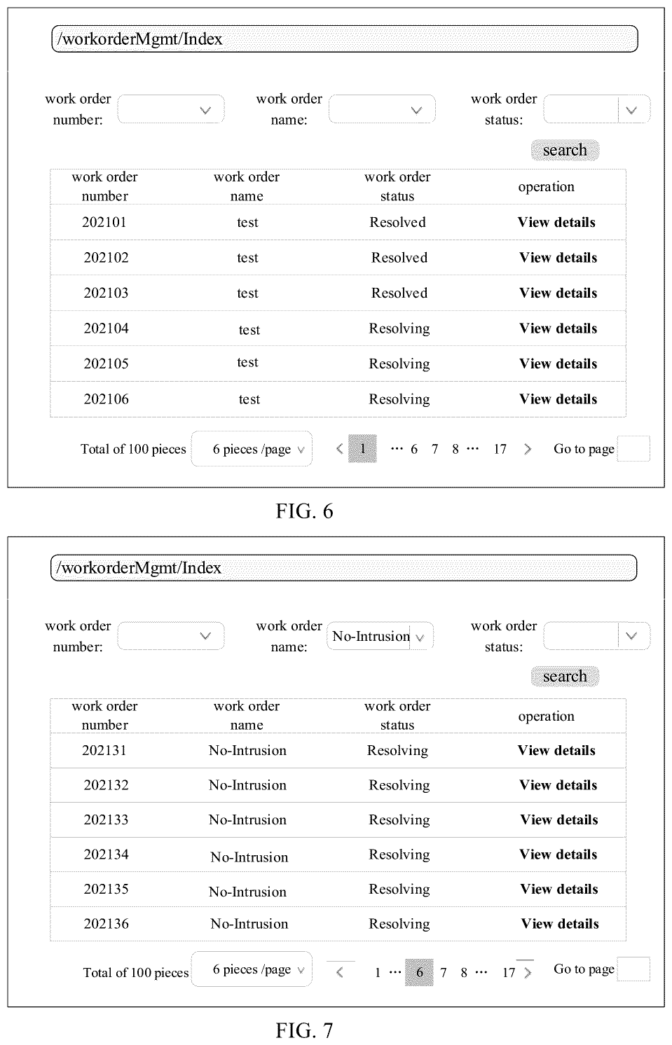

FIG. 6 schematically shows a list page displayed during running of an application program for operation and maintenance services. It can be seen that FIG. 6 shows the initial state of a list page, that is, the original list page, and the corresponding query condition is “name:″, pageNum: 1”, that is, the data of the first page without a filtering condition. The list page includes a list page URL “/workorderMgmt/Index” and 6 pieces of list data. Each piece of list data includes work order number, work order name and work order status. For example, the first piece of list data is a test work order with a work order number 202101. The current status of the work order is resolved. It is understandable that each piece of list data in the list page may be used as target data. When a user selects a piece of list data, that is, when a work order is selected, a “View Details” operation corresponding to the work order may be performed to enter the detail page of the work order from the current list page. The “work order number”, “work order name” and “work order status” may be used as a filtering condition, and the page number and 6 pieces of data per page may be used as a paging condition. In addition, a user may also directly select a target page number to go to a corresponding intermediate list page.

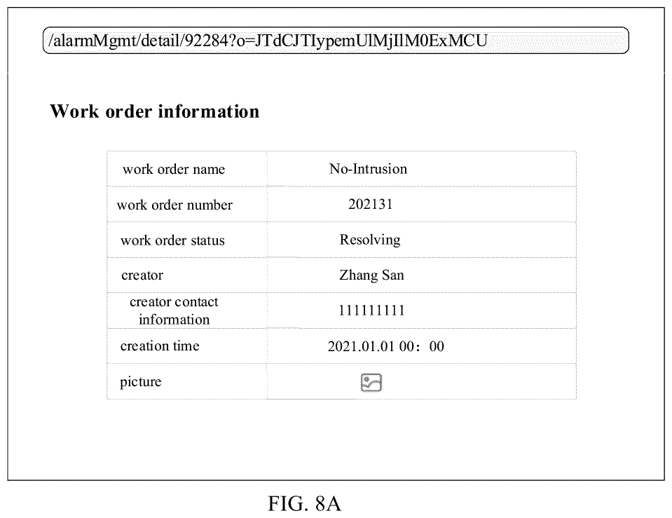

For example, when the user enters a work order name “No-Intrusion”, the user may click/tap a search button to perform filtering on 100 pieces of list data. After the filtering is completed, the list page where the “No-Intrusion” work order is located may be displayed to the user. Referring to FIG. 7, a list page with a filtering condition and a paging condition is schematically provided, that is, an intermediate list page. It can be seen that the query condition corresponding to the list page is “name: No-Intrusion, pageNum: 6”, the URL of the list page is the same as the URL of the list page in FIG. 6, both are “/workorderMgmt/Index”. The six pieces of list data in FIG. 7 are all “No-Intrusion” work orders.

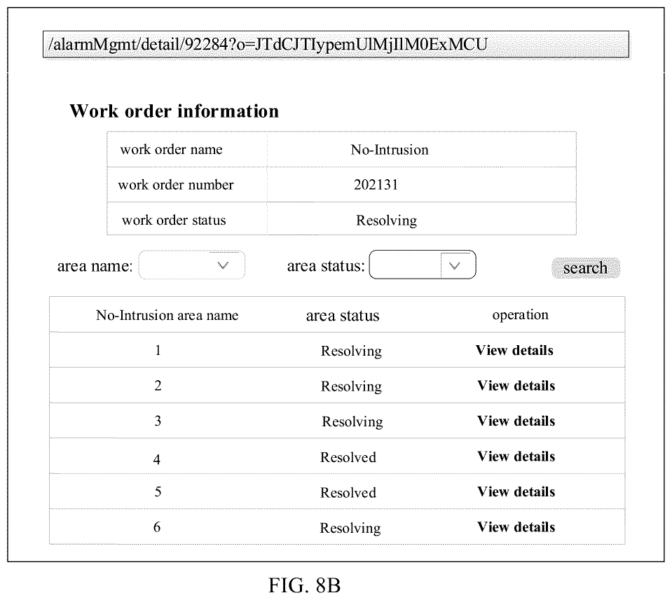

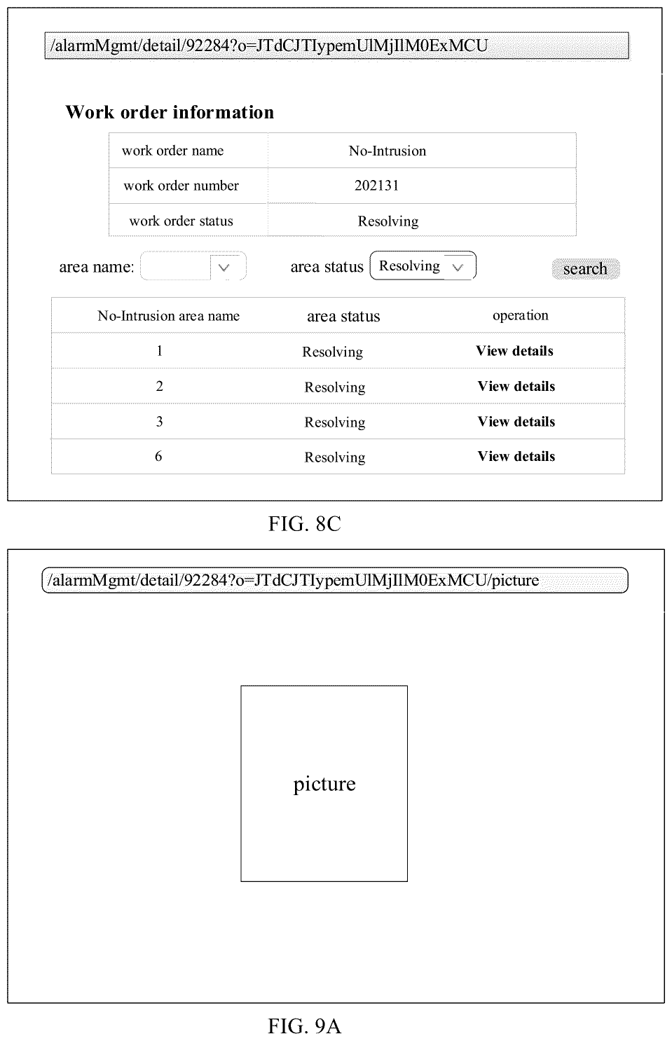

Each piece of list data in FIG. 7 may be used as the first target data. When the user performs a view details operation on a certain piece of list data, jumping from the list page shown in FIG. 7 to a detail page corresponding to the list data may be performed. For example, when the user selects the No-Intrusion work order with work order number 202131 and performs the view details operation, the detail page of the work order is navigated to from the current list page, for example, the detail page as shown in FIG. 8A is navigated to. The detail page page URL includes the detail “/alarmMgmt/detail/92284?o=JTdCJTIypemUlMjIlM0ExMCU” and 6 items of detail data, which are work order name, work order number, work order status, creator, creator contact information, creation time and related image. When returning from the detail page, the list page shown in FIG. 7 may be returned to, to directly display the list data on page 6 with the filtering condition “No-Intrusion” to the user without returning to the list page shown in FIG. 6. The last query result can be retained when returning from the detail page to the list page, making it easier for a user to view and improving user experience. For another example, when the user selects the no-intrusion work order with work order number 202131 and performs the view details operation, the detail page of the work order may be navigated to from the current list page, for example, the detail page as shown in FIG. 8B may be navigated to. In addition to detail data such as the detail page URL and work order name, work order number, and work order status, the detail page further includes 6 items of list data related to the work order number, which are no-intrusion area 1 to no-intrusion area 6. It can be seen that the no-intrusion work order with work order number 202131 is used to operate, maintain and manage the no-intrusion area 1 to the no-intrusion area 6. These six items of list data can also be filtered based on the area name or area status. For example, the work order detail page with the filtering condition “Resolving” as shown in FIG. 8C can be obtained.

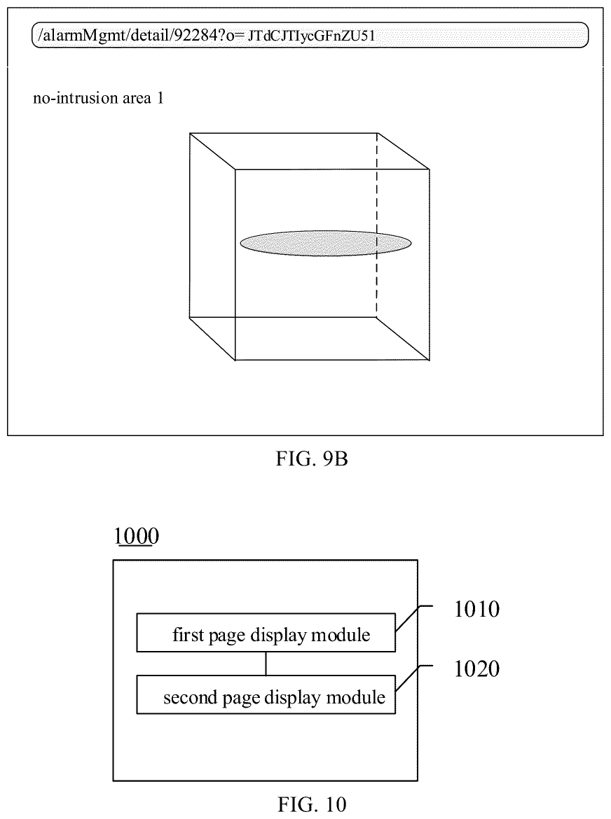

In FIG. 8A, when the detail data is also associated with a detail page, the detail data may be taken as the second target data. For example, when the user clicks on the image label, jumping from the detail page shown in FIG. 8A to the detail page for displaying the image as shown in FIG. 9A may be performed. The URL of the detail page is “/alarmMgmt/detail/92284?o=JTdCJTIypemUlMjIlM0ExMCU/picture”. When returning from the detail page, the detail page shown in FIG. 8A can be returned to, instead of returning to the list page shown in FIG. 7 or FIG. 6. The last query result can also be retained during the page return procedure to facilitate user viewing, thereby improving user experience.

In FIG. 8C, when filtered list data is also associated with a detail page, the list data may be taken as the second target data. When the user performs the view details operation on a certain piece of list data in FIG. 8C, jumping from the filtered work order detail page shown in FIG. 8C to the detail page corresponding to the list data may be performed. For example, when the user performs the view details operation on the no-intrusion area 1, the detail page of the no-intrusion area 1 may be directly navigated to from the current work order detail page. For example, the detail page as shown in FIG. 9B may be navigated to. The cube area indicates the no-intrusion area 1, and the elliptical area is used to indicate the range where intrusion is prohibited in the no-intrusion area 1. When returning from the detail page of the no-intrusion area 1, the detail page shown in FIG. 8C can be navigated to, instead of the work order detail page shown in FIG. 8B or the list page shown in FIG. 7 or FIG. 6. The last query result can be retained during the page return procedure, so that operation and maintenance personnel can quickly and efficiently determine the next no-intrusion area to be viewed when conducting security inspections, and can promptly control and handle sudden site intrusions, and thus improve user experience.

It can be understood that when the user performs the operation of viewing details of a certain piece of list data in FIG. 6, jumping from the list page shown in FIG. 6 to the detail page corresponding to the list data may be performed. When returning from the detail page, jumping back to the list page shown in FIG. 6 may be performed, that is, returning to the initial state of the list page. This also implements the function of retaining the last query result when returning to the list page from the detail page.

It should also be noted that in an example embodiment of the present disclosure, the page jump function, the parameter parsing function and the option variable may be encapsulated into an executable file in advance and stored in the browser, so that when a query operation for the target data in the list page is received, the executable file is executed. The executable file may further include source codes such as parameters reg, from and next, as well as algorithm source codes for encoding and encryption, etc. That is, the source code(s) can be encapsulated according to actual needs of a user to obtain the executable file required by the user. There are no specific restrictions on this. For example, webpack (a module packager) under the Vue framework may be used to package related source codes such as the source code of the list page, the source code of the detail page, the page jump function, the parameter parsing function, and the option variable, and to store them in the form of a folder in the server. A user can make data request to the server when using the local browser to request related source codes involved in the present disclosure, such as the page jump function, the parameter parsing function, the option variable optionsDefault, the parameters reg, from and next, the encodeURIComponent function and the decodeURIComponent. Preferably, when the user accesses the URL address of the list page for the first time, the prepackaged executable file can be co-deployed to the local browser, which can avoid frequent data request to the server. The page display method provided by the example embodiments of the present disclosure has clear logic, simple architecture, and lightweight and is easy to implement, and does not occupy too much memory. It is understandable that the page display method refers to data processing on the browser side.

In the page display method provided by the example embodiments of the present disclosure, when a query operation for the target data in the list page is received, jumping from the list page to the detail page corresponding to the target data is performed, and the first page locating identifier of the detail page is stored. The first page locating identifier includes the page jump parameter. The page jump parameter is obtained, and jumping from the detail page back to the list page is performed according to the page jump parameter. The present disclosure can retain the page jump parameter when entering the detail page from the list page. When returning from the detail page, the previous list page can be restored according to the page jump parameter. The present disclosure can avoid page refresh due to page jump, and a user can obtain the last query result without performing an operation again, thus improving the user experience.

It should be noted that although various steps of the methods of the present disclosure are depicted in a specific order in the drawings, this does not require or imply that these steps must be performed in that specific order, or that all of the illustrated steps must be performed to achieve the desired results. Additionally or alternatively, certain steps may be omitted, multiple steps may be combined into one step for execution, and/or one step may be decomposed into multiple steps for execution, etc.

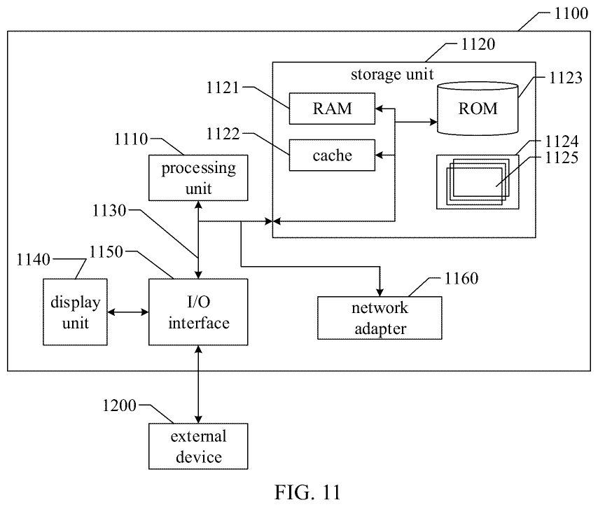

Furthermore, an example embodiment provides a page display apparatus. The apparatus may be applied to a terminal device or a server. Referring to FIG. 10, the page display apparatus 1000 may include a first page display module 1010 and a second page display module 1020.

The first page display module 1010 is configured to, when a query operation for target data in a list page is received, jump from the list page to a detail page corresponding to the target data, and store a first page locating identifier of the detail page, wherein the first page locating identifier includes a page jump parameter.

The second page display module 1020 is configured to obtain the page jump parameter, and jumping from the detail page back to the list page according to the page jump parameter.

In an optional implementation, the list page includes an original list page and an intermediate list page. The first page display module 1010 includes:
a page switching module configured to, when a trigger operation for a search control in the original list page is received, switch the original list page to the intermediate list page according to the page jump parameter; and
a page jump module configured to, when a query operation for first target data in the intermediate list page is received, jump from the intermediate list page to a first detail page corresponding to the first target data, and store a first page locating identifier of the first detail page.

In an optional implementation, the page jump module includes:
a parameter obtaining unit configured to, when the query operation for the first target data in the intermediate list page is received, obtain the page jump parameter and a second page locating identifier of the first detail page;
a parameter converting unit configured to convert the page jump parameter into a target parameter string through a page jump function;
an identifier generation unit configured to form the first page locating identifier of the first detail page by the target parameter string and the second page locating identifier; and
a first page jump unit configured to jump from the intermediate list page to the first detail page according to the first page locating identifier of the first detail page.

In an optional implementation, the parameter converting unit includes:
a parameter converting subunit configured to convert the page jump parameter into an initial parameter string; and
a string encoding subunit configured to encode the initial parameter string to obtain the target parameter string.

In an optional implementation, the parameter converting unit includes:
a parameter converting subunit configured to convert the page jump parameter into an initial parameter string;
a string encoding subunit configured to encode the initial parameter string to obtain a first parameter string; and
a string encryption subunit configured to encrypt the first parameter string to obtain the target parameter string.

In an optional implementation, the second page display module 1020 includes:
a string obtaining module configured to obtain the target parameter string through a parameter parsing function;
a string parsing module configured to parse the target parameter string to obtain the page jump parameter; and
a second page jump module configured to jump from the first detail page back to the intermediate list page according to the page jump parameter.

In an optional implementation, the string obtaining module includes:
a string check unit configured to determine, through the parameter parsing function, whether the first page locating identifier of the first detail page satisfies a preset matching rule and whether the first page locating identifier includes a preset parameter; and
a string obtaining unit configured to, when the first page locating identifier of the detail page satisfies the preset matching rule and the first page locating identifier includes the preset parameter, obtain the target parameter string.

In an optional implementation, the string parsing module includes:

a string decoding unit configured to decode the target parameter string to obtain the initial parameter string, and convert the initial parameter string into the page jump parameter.

In an optional implementation, the string parsing module includes:
a string decryption unit configured to decrypt the target parameter string to obtain the first parameter string; and
a string decoding unit configured to decode the first parameter string to obtain the initial parameter string, and convert the initial parameter string into the page jump parameter.

In an optional implementation, the second page jump module includes:
a parameter assigning unit configured to assign a current value of the page jump parameter to an option variable, wherein the option variable is used to save a default value of the page jump parameter; and
a page jump unit configured to jump from the first detail page back to the intermediate list page according to the option variable after assigning.

In an optional implementation, after jumping from the intermediate list page to the first detail page corresponding to the first target data, the page display apparatus 1000 further includes:
a third page display module 1030 configured to, when a query operation for second target data in the first detail page is received, jump from the first detail page to a second detail page corresponding to the second target data, and store a page locating identifier of the second detail page; and obtain a page jump parameter included in the page locating identifier of the second detail page, and jump from the second detail page back to the first detail page according to the page jump parameter.

In an optional implementation, after jumping from the intermediate list page to the first detail page corresponding to the first target data, the page display apparatus 1000 further includes:
a third page display module 1040 configured to: when a query operation for second target data in the first detail page is received, jump from the first detail page to a second detail page corresponding to the second target data, and store a page locating identifier of the second detail page; determine the first page locating identifier of the first detail page according to the page locating identifier of the second detail page; and jump from the second detail page back to the first detail page according to the first page locating identifier of the first detail page.

The specific details of each module in the above page display apparatus have been described in detail in the corresponding page display methods, and thus they will not be described again here.

Each module in the above apparatus may be a general-purpose processor, including a central processing unit, a network processor, etc.; or, each module in the above apparatus may be a digital signal processor, an application-specific integrated circuit, a field programmable gate array or other programmable logic device, discrete gate or transistor logic device, or discrete hardware component. Each module may also be implemented in the form of software, or firmware, etc. Each processor in the above apparatus can be an independent processor or can be integrated together.

An example embodiment of the present disclosure also provides a computer-readable storage medium having stored thereon a program product capable of implementing the above methods according to embodiments of the present disclosure. In some possible implementations, aspects of the present disclosure may also be implemented in the form of a program product, which includes program codes. When the program product is run on an electronic device, the program codes are configured to cause the electronic device to perform the steps according to various example embodiments of the present disclosure described in the above-mentioned “example methods” section of the present specification. The program product may adopt a portable compact disc read-only memory (CD-ROM) and include program codes, and may be executed on an electronic device, such as a personal computer. However, the program product of the present disclosure is not limited thereto. The readable storage medium may be any tangible medium containing or storing a program, and the program may be used by an instruction execution system, apparatus, or device, or the program may be used in combination with an instruction execution system, apparatus, or device.

The program product may adopt any combination of one or more readable mediums. The readable medium may be a readable signal medium or a readable storage medium. The readable storage medium may be, for example, but is not limited to, an electronic, magnetic, optical, electromagnetic, infrared, or semiconductor system, apparatus, or device, or any combination thereof. More specific examples (non-exhaustive examples) of readable storage media include: electrical connection with one or more wires, portable disk, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing.

The computer-readable signal medium may include a data signal in baseband or propagated as part of a carrier wave, which carries readable program codes. Such a propagated data signal may have many forms, including but not limited to an electromagnetic signal, an optical signal, or any suitable combination of the foregoing. The readable signal medium may also be any readable medium other than a readable storage medium, and the readable medium may send, propagate, or transmit a program that is used by an instruction execution system, apparatus, or device, or that is used in combination with an instruction execution system, apparatus, or device.

The program codes contained on the readable medium may be transmitted using any appropriate medium, including but not limited to wireless, wired, optical fiber, RF, etc., or any suitable combination of the foregoing.

The program codes for performing the operations of the present disclosure can be written in any combination of one or more programming languages, which include object-oriented programming languages, such as Java, C++, and so on. The programming languages also include conventional procedural programming language, such as “C” or a similar programming language. The program codes can be executed entirely on the user computing device, can be executed partly on the user device, can be executed as an independent software package, can be executed partly on the user computing device and partly on a remote computing device, or can be executed entirely on the remote computing device or a server. In the case of a remote computing device, the remote computing device can be connected to the user computing device through any kind of network, including a local area network (LAN) or a wide area network (WAN), or the remote computing device can be connected to an external computing device, for example, through the Internet provided by the Internet service providers.

An example embodiment of the present disclosure further provides an electronic device capable of implementing the above methods. An electronic device 1100 according to an example implementation of the present disclosure is described below with reference to FIG. 11. The electronic device 1100 shown in FIG. 11 is only an example, and should not impose any limitation on the functions and scope of use of the embodiments of the present disclosure.

As shown in FIG. 11, the electronic device 1100 is shown in the form of a general-purpose computing device. The components of the electronic device 1100 may include, but are not limited to, at least one processing unit 1110, at least one storage unit 1120, and a bus 1130 connecting different system components (including the storage unit 1120 and the processing unit 1110) and a display unit 1140.

The storage unit 1120 stores program codes, and the program codes can be executed by the processing unit 1110, so that the processing unit 1110 executes steps of various example embodiments according to the present disclosure described in the “example methods” section of the present specification. For example, the processing unit 1110 may perform any one or more of the method steps in FIG. 2 to FIG. 5.

The storage unit 1120 may include a readable medium in the form of a volatile storage unit, such as a random access storage unit (RAM) 11201 and/or a cache storage unit 1122, and may further include a read-only storage unit (ROM) 1123.

The storage unit 1120 may further include a program/utility tool 1124 having a set (at least one) of program modules 1125. Such program modules 1125 include, but are not limited to, an operating system, one or more application programs, other program modules, and program data. Each or some combination of these examples may include an implementation of a network environment.

The bus 1130 may be one or more of several types of bus structures, including a memory unit bus or a memory unit controller, a peripheral bus, a graphics acceleration port, a processing unit, or a local area bus using any bus structure in a variety of bus structures.

The electronic device 1100 may also communicate with one or more external devices 1200 (such as a keyboard, a pointing device, a Bluetooth device, etc.), and may also communicate with one or more devices that enable a user to interact with the electronic device 1100, and/or may also communicate with any device (such as a router, a modem) that can enable the electronic device 1100 to interact with one or more other computing devices. Such communication can be performed through an input/output (I/O) interface 1150. Moreover, the electronic device 1100 may also communicate with one or more networks (such as a local area network (LAN), a wide area network (WAN), and/or a public network, such as the Internet) through the network adapter 1160. As shown in the figure, the network adapter 1160 communicates with other modules of the electronic device 1100 through the bus 1130. It should be understood that although not shown in the figure, other hardware and/or software modules may be used in conjunction with the electronic device 1100, including but not limited to: microcode, device drivers, redundant processing units, external disk drive arrays, RAID systems, tape drives and data backup storage systems.

Through the description of the foregoing implementations, those skilled in the art can easily understand that the example implementations described herein can be implemented by software, or by software in combination with necessary hardware. Therefore, the technical solutions according to the implementations of the present disclosure may be embodied in the form of a software product, and the software product may be stored in a non-volatile storage medium (which may be a CD-ROM, a U disk, a mobile hard disk, etc.) or on a network. The software product may include instructions to cause a computing device (which may be a personal computer, a server, a terminal device, or a network device, etc.) to perform the methods according to example implementations of the present disclosure.

In addition, the above-mentioned drawings are only schematic illustrations of processes included in the methods according to the example implementations of the present disclosure, and are not intended to be limiting. It is readily understood that the processes shown in the above drawings do not indicate or limit the temporal sequence of these processes. In addition, it is also easy to understand that these processes may be performed synchronously or asynchronously in multiple modules, for example.

It should be noted that although several modules or units of device for action execution are mentioned in the above detailed description, such division is not mandatory. In fact, according to an implementation of the present disclosure, the features and functions of two or more modules or units described above may be embodied in one module or unit. Conversely, the features and functions of one module or unit described above may be further divided to be embodied by multiple modules or units. It is to be understood that the present disclosure is not limited to the precise structures described above and illustrated in the accompanying drawings, and various modifications and changes may be made without departing from the scope of the present disclosure. The scope of the disclosure is limited only by the appended claims.

1. A page display method, comprising:
when a query operation for target data in a list page is received, jumping from the list page to a detail page corresponding to the target data, and storing a first page locating identifier of the detail page, wherein the first page locating identifier comprises a page jump parameter; and
obtaining the page jump parameter, and jumping from the detail page back to the list page according to the page jump parameter.

2. The page display method according to claim 1, wherein the list page comprises an original list page and an intermediate list page;
wherein when the query operation for the target data in the list page is received, jumping from the list page to the detail page corresponding to the target data, and storing the first page locating identifier of the detail page, comprises:
when a trigger operation for a search control in the original list page is received, switching the original list page to the intermediate list page according to the page jump parameter; and
when a query operation for first target data in the intermediate list page is received, jumping from the intermediate list page to a first detail page corresponding to the first target data, and storing a first page locating identifier of the first detail page.

3. The page display method according to claim 2, wherein when the query operation for the first target data in the intermediate list page is received, jumping from the intermediate list page to the first detail page corresponding to the first target data comprises:
when the query operation for the first target data in the intermediate list page is received, obtaining the page jump parameter and a second page locating identifier of the first detail page;
converting the page jump parameter into a target parameter string through a page jump function;
forming the first page locating identifier of the first detail page by the target parameter string and the second page locating identifier; and
jumping from the intermediate list page to the first detail page according to the first page locating identifier of the first detail page.

4. The page display method according to claim 3, wherein converting the page jump parameter into the target parameter string through the page jump function comprises:
converting the page jump parameter into an initial parameter string; and
encoding the initial parameter string to obtain the target parameter string.

5. The page display method according to claim 3, wherein converting the page jump parameter into the target parameter string through the page jump function comprises:
converting the page jump parameter into an initial parameter string;
encoding the initial parameter string to obtain a first parameter string; and
encrypting the first parameter string to obtain the target parameter string.

6. The page display method according to claim 3, wherein obtaining the page jump parameter and jumping from the detail page back to the list page according to the page jump parameter comprises:
obtaining the target parameter string through a parameter parsing function;
parsing the target parameter string to obtain the page jump parameter; and
jumping from the first detail page back to the intermediate list page according to the page jump parameter.

7. The page display method according to claim 6, wherein obtaining the target parameter string through the parameter parsing function comprises:
determining, through the parameter parsing function, whether the first page locating identifier of the first detail page satisfies a preset matching rule and whether the first page locating identifier comprises a preset parameter; and
when the first page locating identifier of the first detail page satisfies the preset matching rule and the first page locating identifier comprises the preset parameter, obtaining the target parameter string.

8. The page display method according to claim 6, wherein parsing the target parameter string to obtain the page jump parameter comprises:
decoding the target parameter string to obtain the initial parameter string, and converting the initial parameter string into the page jump parameter.

9. The page display method according to claim 6, wherein parsing the target parameter string to obtain the page jump parameter comprises:
decrypting the target parameter string to obtain the first parameter string; and
decoding the first parameter string to obtain the initial parameter string, and converting the initial parameter string into the page jump parameter.

10. The page display method according to claim 6, wherein jumping from the first detail page back to the intermediate list page according to the page jump parameter comprises:
assigning a current value of the page jump parameter to an option variable, wherein the option variable is used to save a default value of the page jump parameter; and
jumping from the first detail page back to the intermediate list page according to the option variable after assigning.

11. The page display method according to claim 2, wherein after jumping from the intermediate list page to the first detail page corresponding to the first target data, the method further comprises:
when a query operation for second target data in the first detail page is received, jumping from the first detail page to a second detail page corresponding to the second target data, and storing a page locating identifier of the second detail page; and
obtaining a page jump parameter comprised in the page locating identifier of the second detail page, and jumping from the second detail page back to the first detail page according to the page jump parameter.

12. The page display method according to claim 2, wherein after jumping from the intermediate list page to the first detail page corresponding to the first target data, the method further comprises:
when a query operation for second target data in the first detail page is received, jumping from the first detail page to a second detail page corresponding to the second target data, and storing a page locating identifier of the second detail page;
determining the first page locating identifier of the first detail page according to the page locating identifier of the second detail page; and
jumping from the second detail page back to the first detail page according to the first page locating identifier of the first detail page.

13. The page display method according to claim 10, wherein the page jump function, the parameter parsing function and the option variable are encapsulated in advance into an executable file which is stored in a browser so that the executable file is executed when the query operation for the target data in the list page is received, wherein:
the page jump function is used to convert the page jump parameter into a target parameter string, the first page locating identifier of the first detail page is formed by the target parameter string and the second page locating identifier, and jumping from the intermediate list page to the first detail page is according to the first page locating identifier of the first detail page;
the parameter parsing function is used to obtain the target parameter string, parse the target parameter string to obtain the page jump parameter, and jumping from the first detail page back to the intermediate list page is according to the page jump parameter; and
the option variable is used to save a default value of the page jump parameter.

14. (canceled)

15. A non-transitory computer-readable storage medium on which a computer program is stored, wherein when the computer program is executed by a processor, the processor is caused to:
when a query operation for target data in a list page is received, jump from the list page to a detail page corresponding to the target data, and store a first page locating identifier of the detail page, wherein the first page locating identifier comprises a page jump parameter; and
obtain the page jump parameter, and jump from the detail page back to the list page according to the page jump parameter.

16. An electronic device, comprising:
a processor; and
a memory configured to store instructions executable by the processor;
wherein the processor is configured to execute the instructions to:
when a query operation for target data in a list page is received, jump from the list page to a detail page corresponding to the target data, and store a first page locating identifier of the detail page, wherein the first page locating identifier comprises a page jump parameter; and
obtain the page jump parameter, and jump from the detail page back to the list page according to the page jump parameter.

17. The electronic device according to claim 16, wherein the list page comprises an original list page and an intermediate list page;
wherein the processor is configured to:
when a trigger operation for a search control in the original list page is received, switch the original list page to the intermediate list page according to the page jump parameter; and
when a query operation for first target data in the intermediate list page is received, jump from the intermediate list page to a first detail page corresponding to the first target data, and store a first page locating identifier of the first detail page.

18. The electronic device according to claim 17, wherein the processor is configured to:
when the query operation for the first target data in the intermediate list page is received, obtain the page jump parameter and a second page locating identifier of the first detail page;
convert the page jump parameter into a target parameter string through a page jump function;
form the first page locating identifier of the first detail page by the target parameter string and the second page locating identifier; and
jump from the intermediate list page to the first detail page according to the first page locating identifier of the first detail page.

19. The electronic device according to claim 18, wherein the processor is configured to:
convert the page jump parameter into an initial parameter string; and
encode the initial parameter string to obtain the target parameter string.

20. The electronic device according to claim 18, wherein the processor is configured to:
convert the page jump parameter into an initial parameter string;
encode the initial parameter string to obtain a first parameter string; and
encrypt the first parameter string to obtain the target parameter string.
